(19) United States
(12) Patent Application Publication
(10) Pub. No.: US 2003/0142879 A1
(43) Pub. Date: Jul. 31, 2003

(54) Apparatus and method for adjusting saturation of color image

(75) Inventor: Moon-cheol Kim, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/318,382

(22) Filed: Dec. 13, 2002

(30) Foreign Application Priority Data
Dec. 24, 2001 (KR) 2001-84109

(51) Int. Cl. G06K 9/40; G06K 9/00

(52) U.S. Cl. 382/274; 382/162; 382/168

(57) ABSTRACT

An apparatus and method of adjusting the saturation of a color image. A saturation value for each of a plurality of pixels of an input image is calculated, and a peak saturation value and a mean saturation value of the input image are calculated using the saturation values of the pixels. A peak gain value based on the peak saturation value and a mean gain value based on the mean saturation value are calculated. A local gain value is calculated using the mean gain value and the saturation values of the pixels. A pattern gain value for a test pattern image and a color gain value for a skin color image are also considered to adaptively adjust the saturation of the input image.

### CROSS-REFERENCE TO RELATED APPLICATIONS

This application claims the benefit of Korean Application No. 2001-84109, filed Dec. 24, 2001, in the Korean Intellectual Property Office, the disclosure of which is incorporated herein by reference.

### BACKGROUND OF THE INVENTION

1. Field of the Invention

The present invention relates to an apparatus and method of adjusting the saturation of a color image, and more particularly, to an apparatus and method of adjusting the color saturation of an input image in a digital TV, photo-shop, digital camera, camcorder, or computer-based image processor to provide a quality image to a user.

2. Description of the Related Art

A conventional image processor increases the saturation of an input image irrespective of the characteristics of the input image. As an example, when the background saturation is increased in a TV screen, the saturation of a facial image of persons is also increased, so that the persons appear unnatural due to the super-saturation of the skin color.

A conventional image enhancement system processes input data without considering whether the input data is a test pattern image, thereby making it difficult to control the quality of the image to be displayed on a particular display.

### SUMMARY OF THE INVENTION

Accordingly, it is an aspect of the present invention to provide an apparatus and method of adaptively adjusting the saturation of an input color image which considers the characteristics of the input color image.

It is another aspect of the present invention to provide an apparatus and method of selectively adjusting the saturation in a particular region of an input image while maintaining the skin color of the input image, thereby providing a user with a natural looking color.

It is another aspect of the present invention to provide an apparatus and method of adaptively adjusting the saturation of a color image, in which a test pattern image is input, and the saturation adjustment is bypassed to enable quality control of the image to be displayed on a particular display.

Additional aspects and advantages of the invention will be set forth in part in the description which follows and, in part, will be obvious from the description, or may be learned by practice of the invention.

The foregoing and/or other aspects of the present invention may be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; and a saturation adjustor which adaptively adjusts a saturation of the input image using the peak gain value calculated by the peak gain calculator.

The foregoing and/or other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a pattern gain calculator which determines whether the input image is a predetermined pattern image and calculates a pattern gain value for the predetermined pattern image depending on whether the input image is determined to be the predetermined pattern image; and a saturation adjustor which adaptively adjusts a saturation of the input image using the peak gain value calculated by the peak gain calculator and the pattern gain value calculated by the pattern gain calculator.

The foregoing and/or other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a color gain calculator which determines whether each of the pixels of the input image belongs to a color region and calculates a color gain value for the pixels depending on whether the pixels belong to the color region; and a saturation adjustor which adaptively adjusts the saturation for each of the pixels of the input image using the peak gain value calculated by the peak gain calculator and the color gain value calculated by the color gain calculator.

The foregoing and other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a pattern gain calculator which determines whether the input image is a predetermined pattern image and calculates a pattern gain value depending on whether the input image is determined to be the predetermined pattern image; a color gain calculator which determines whether each of the pixels of the input image belongs to a color region and calculates a color gain value for the pixels depending on whether the pixels belong to the color region; and a saturation adjustor which adaptively adjusts the saturation of each of the pixels of the input image using the peak gain value calculated by the peak gain calculator, the pattern gain value calculated by the pattern gain calculator, and the color gain value calculated by the color gain calculator.

The foregoing and other aspects of the present invention may also be achieved by providing an apparatus to adjust a saturation of a color image, including a saturation calculator which calculates a saturation value for each of a plurality of pixels of an input image; a mean saturation calculator which calculates a mean saturation value of the input image using the saturation values calculated by the saturation calculator; a mean gain calculator which calculates a mean gain value based on the mean saturation value calculated by the mean saturation calculator; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value.

The foregoing and/or other aspects of the present invention may also be achieved by providing an apparatus to adjust the saturation of a color image, including a saturation calculator which calculates a saturation value for each of a plurality of pixels of an input image; a mean saturation calculator which calculates a mean saturation value of the input image using the saturation values calculated by the saturation calculator; a mean gain calculator which calculates a mean gain value based on the mean saturation value calculated by the mean saturation calculator; a pattern gain calculator which determines whether the input image is a predetermined pattern image and calculates a pattern gain value depending on whether the input image is determined to be the predetermined pattern image; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value and the pattern gain value calculated by the pattern gain calculator.

The foregoing and/or other aspects of the present invention may also be achieved by providing an apparatus to adjust a saturation of a color image, including a saturation calculator which calculates a saturation value for each of a plurality of pixels of an input image; a mean saturation calculator which calculates a mean saturation value of the input image using the saturation values calculated by the saturation calculator; a mean gain calculator which calculates a mean gain value based on the mean saturation value calculated by the mean saturation calculator; a color gain calculator which determines whether each of the pixels of the input image belongs to a color region of the input image and calculates a color gain value for the pixels depending on whether the pixels belong to the color region; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value and the color gain value calculated by the color gain calculator.

The foregoing and/or other aspects of the present invention may also be achieved by providing an apparatus to adjust a saturation of a color image, including a saturation calculator which calculates a saturation value for each of a plurality of pixels of an input image; a mean saturation calculator which calculates a mean saturation value of the input image using the saturation values calculated by the saturation calculator; a mean gain calculator which calculates a mean gain value based on the mean saturation value calculated by the mean saturation calculator; a pattern gain calculator which determines whether the input image is a predetermined pattern image and calculates a pattern gain value depending on whether the input image is determined to be the predetermined pattern image; a color gain calculator which determines whether each of the pixels of the input image belongs to a color region of the input image and calculates a color gain value for the pixels depending on whether the pixels belong to the color region; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value, the pattern gain value calculated by the pattern gain calculator, and the color gain value calculated by the color gain calculator.

The foregoing and/or other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a mean saturation calculator which calculates a mean saturation value of the input image using the saturation values calculated by the saturation calculator; a mean gain calculator which calculates a mean gain value based on the mean saturation value calculated by the mean saturation calculator; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value and the peak gain value calculated by the peak gain calculator.

The foregoing and/or other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a mean saturation calculator which calculates a mean saturation value of the input image using the saturation values calculated by the saturation calculator; a mean gain calculator which calculates a mean gain value based on the mean saturation value calculated by the mean saturation calculator; a pattern gain calculator which determines whether the input image is a predetermined pattern image and calculates a pattern gain value depending on whether the input image is determined to be the predetermined pattern image; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value, the peak gain value calculated by the peak gain calculator, and the pattern gain value calculated by the pattern gain calculator.

The foregoing and/or other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a mean saturation calculator which calculates a mean saturation value of the input image using the saturation values calculated by the saturation calculator; a mean gain calculator which calculates a mean gain value based on the mean saturation value calculated by the mean saturation calculator; a color gain calculator which determines whether the pixels of the input image belong to a color region and calculates a color gain value for the pixels depending on whether the pixels belong to the color region; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value, the peak gain value calculated by the peak gain calculator, and the color gain value calculated by the color gain calculator.

The foregoing and/or other aspects of the present invention may also be achieved by providing an apparatus to adjust a saturation of a color image, including a saturation calculator which calculates a saturation value for each of a plurality of pixels of an input image; a peak saturation calculator which determines a peak saturation value of the input image using the saturation values calculated by the saturation calculator; a peak gain calculator which calculates a peak gain value based on the peak saturation value determined by the peak saturation calculator; a mean saturation calculator which calculates a mean saturation value of the input image using the saturation values calculated by the saturation calculator; a mean gain calculator which calculates a mean gain value based on the mean saturation value calculated by the mean saturation calculator; a pattern gain calculator which determines whether the input image is a predetermined pattern image and calculates a pattern gain value depending on whether the input image is determined to be the predetermined pattern image; a color gain calculator which determines whether each of the pixels of the input image belongs to a color region and calculates a color gain value for the pixels depending on whether the pixels belong to the predetermined color region; and a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value, the peak gain value calculated by the peak gain calculator, the pattern gain value calculated by the pattern gain calculator, and the color gain value calculated by the color gain calculator.

The foregoing and/or other aspects of the present invention may also be achieved by providing a method of adjusting a saturation of a color image, including calculating a saturation value for each of a plurality of pixels of an input image; determining a peak saturation value of the input image using the calculated saturation values; calculating a peak gain value based on the determined peak saturation value; and adaptively adjusting the saturation of the input image using the calculated peak gain value.

The foregoing and/or other aspects of the present invention may also be achieved by providing a method of adjusting a saturation of a color image, including calculating a saturation value for each of a plurality of pixels of an input image; determining a peak saturation value of the input image using the calculated saturation values; calculating a peak gain value based on the determined peak saturation value; determining whether the input image is a predetermined pattern image and calculating a pattern gain value depending on whether the input image is determined to be the predetermined pattern image; and adaptively adjusting the saturation of the input image using the calculated peak gain value and the calculated pattern gain value.

The foregoing and/or other aspects of the present invention may also be achieved by providing a method of adjusting a saturation of a color image, including calculating a saturation value for each of a plurality of pixels of an input image; determining a peak saturation value of the input image based on the calculated saturation values; calculating a peak gain value based on the determined peak saturation value; determining whether each of the pixels of the input image belongs to a color region and calculating a color gain value for the pixels depending on whether the pixels belong to the color region; and adaptively adjusting the saturation of the input image using the calculated peak gain value and the calculated color gain value.

The foregoing and/or other aspects of the present invention may also be achieved by providing a method of adjusting a saturation of a color image, including calculating a saturation value for each of a plurality of pixels of an input image; determining a peak saturation value of the input image using the calculated saturation values; calculating a peak gain value based on the determined peak saturation value; determining whether the input image is a predetermined pattern image and calculating a pattern gain value depending on whether the input image is determined to be the predetermined pattern image; determining whether the pixels of the input image belong to a color region and calculating a color gain value for the pixels depending on whether the pixels belong to the color region; and adaptively adjusting the saturation of each of the pixels of the input image using the calculated peak gain value, the calculated pattern gain value, and the calculated color gain value.

The foregoing and/or other aspects of the present invention may also be achieved by providing a method of adjusting a saturation of a color image, including calculating a saturation value for each of a plurality of pixels of an input image; calculating a mean saturation value of the input image using the calculated saturation values; calculating a mean gain value based on the calculated mean saturation value; and calculating a local gain value for each of the pixels using the calculated mean gain value and the calculated saturation values and adaptively adjusting the saturation of each of the pixels of the input image using the local gain value.

The foregoing and/or other aspects of the present invention may also be achieved by providing a method of adjusting a saturation of a color image, including calculating a saturation value for each of a plurality of pixels of an input image; calculating a mean saturation value of the input image using the calculated saturation values; calculating a mean gain value based on the calculated mean saturation value; determining whether the input image is a predetermined pattern image and calculating a pattern gain value depending on whether the input image is determined to be the predetermined pattern image; and calculating a local gain value for each of the pixels using the calculated mean gain value and the calculated saturation values and adaptively adjusting the saturation of each of the pixels of the input image using the local gain value and the calculated pattern gain value.

The foregoing and/or other aspects of the present invention may also be achieved by providing a method of adjusting a saturation of a color image, including calculating a saturation value for each of a plurality of pixels of an input image; calculating a mean saturation value of the input image using the calculated saturation values; calculating a mean gain value based on the calculated mean saturation value; determining whether each of the pixels of the input image belongs to a color region of the input image and calculating a color gain value for the pixels depending on whether the pixels belong to the color region; and calculating a local gain value for the pixels using the calculated mean gain value and the calculated saturation values and adaptively adjusting the saturation of each of the pixels of the input image using the local gain value and the calculated color gain value.

The foregoing and/or other aspects of the present invention may also be achieved by providing a method of adjusting a saturation of a color image, including calculating a saturation value for each of a plurality of pixels of an input image; calculating a mean saturation value of the input image using the calculated saturation values; calculating a mean gain value based on the calculated mean saturation value; determining whether the input image is a predetermined pattern image and calculating a pattern gain value depending on whether the input image is determined to be the predetermined pattern image; determining whether the pixels of the input image belong to a color region of the input image and calculating a color gain value for the pixels depending on whether the pixels belong to the color region; and calculating a local gain value for each of the pixels using the calculated mean gain value and the calculated saturation values and adaptively adjusting the saturation of each of the pixels of the input image using the local gain value, the calculated pattern gain value, and the calculated color gain value.

The foregoing and/or other aspects of the present invention may also be achieved by providing a method of adjusting a saturation of a color image, including calculating a saturation value for each of a plurality of pixels of an input image; determining a peak saturation value of the input image based on the calculated saturation values; calculating a peak gain value based on the determined peak saturation value; calculating a mean saturation value of the input image using the calculated saturation values; calculating a mean gain value based on the calculated mean saturation value; and calculating a local gain value for each of the pixels using the calculated mean gain value and the calculated saturation values and adaptively adjusting the saturation of each of the pixels of the input image using the calculated local gain value and the calculated peak gain value.

The foregoing and/or other aspects of the present invention may also be achieved by providing a method of adjusting a saturation of a color image, including calculating a saturation value for each of a plurality of pixels of an input image; determining a peak saturation value of the input image based on the calculated saturation values; calculating a peak gain value based on the determined peak saturation value; calculating a mean saturation value of the input image using the calculated saturation values; calculating a mean gain value based on the calculated mean saturation value; determining whether the input image is a predetermined pattern image and calculating a pattern gain value depending on whether the input image is determined to be the predetermined pattern image; and calculating a local gain value for each of the pixels using the calculated mean gain value and the calculated saturation values and adaptively adjusting the saturation of each of the pixels of the input image using the local gain value, the calculated peak gain value, and the calculated pattern gain value.

The foregoing and/or other aspects of the present invention may also be achieved by providing a method of adjusting a saturation of a color image, including calculating a saturation value for each of a plurality of pixels of an input image; determining a peak saturation value of the input image based on the calculated saturation values; calculating a peak gain value based on the determined peak saturation value; calculating a mean saturation value of the input image using the calculated saturation values; calculating a mean gain value based on the calculated mean saturation value; determining whether each of the pixels of the input image belongs to a color region of the input image and calculating a color gain value for the pixels depending on whether the pixels belong to the color region; and calculating a local gain value for each of the pixels using the calculated mean gain value and the calculated saturation values and adaptively adjusting the saturation of each of the pixels of the input image using the local gain value, the calculated peak gain value, and the calculated color gain value.

The foregoing and/or other aspects of the present invention may also be achieved by providing a method of adjusting a saturation of a color image, including calculating a saturation value for each of a plurality of pixels of an input image; determining a peak saturation value of the input image using the calculated saturation values; calculating a peak gain value based on the determined peak saturation value; calculating a mean saturation value of the input image using the calculated saturation values; calculating a mean gain value based on the calculated mean saturation value; determining whether the input image is a predetermined pattern image and calculating a pattern gain value depending on whether the input image is determined to be the predetermined pattern image; determining whether each of the pixels of the input image belongs to a color region of the input image and calculating a color gain value for the pixels depending on whether the pixels belong to the color region; and calculating a local gain value for each of the pixels using the calculated mean gain value and the calculated saturation values and adaptively adjusting the saturation of each of the pixels of the input image using the local gain value, the calculated peak gain value, the calculated pattern gain value, and the calculated color gain value.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 shows a saturation adjusting apparatus according to an embodiment of the present invention;

FIG. 2 shows a saturation histogram according to the present invention;

FIG. 3 shows a gain function for a peak gain value according to the present invention;

FIG. 4 shows a pattern gain function for a pattern gain value according to the present invention;

FIG. 5 shows gain functions for a color gain value according to the present invention;

FIG. 6 shows other gain functions for the color gain value according to the present invention;

FIG. 7 shows a saturation adjusting apparatus according to another embodiment of the present invention;

FIG. 8 shows gain functions for a mean gain value and a local gain value according to the present invention; and

FIG. 9 shows a saturation adjusting apparatus according to still another embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

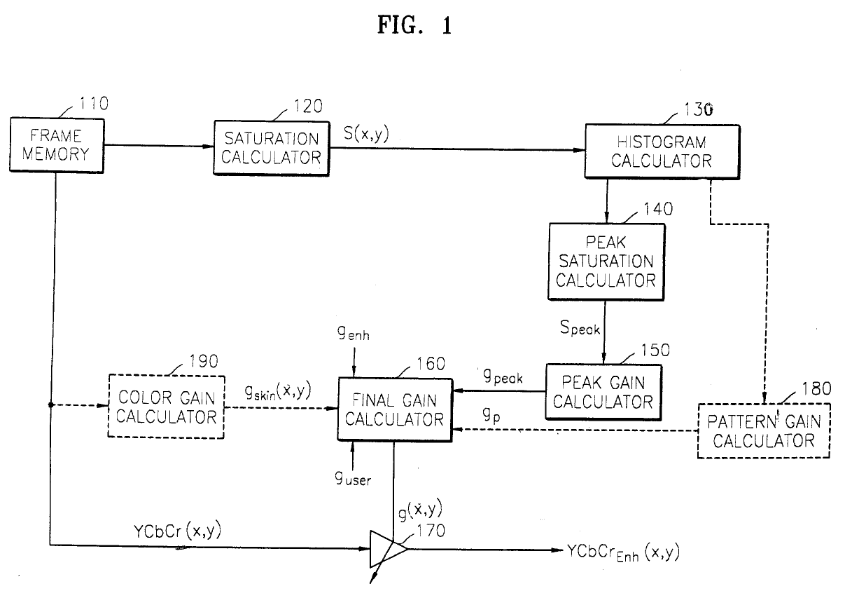

A saturation adjusting apparatus according to an embodiment of the present invention is shown in FIG. 1. Referring to FIG. 1, the saturation adjusting apparatus includes a frame memory 110, a saturation calculator 120, a histogram calculator 130, a peak saturation calculator 140, a peak gain calculator 150, a final gain calculator 160, and a saturation adjustor 170.

The frame memory 110 stores an input image signal. The saturation calculator 120 calculates a saturation value S(x,y) for all of the pixels stored in the frame memory 110. The histogram calculator 130 calculates a saturation histogram for all of the pixels of the image or a local window region from the saturation value S(x,y) of each of the pixels calculated by the saturation calculator 120. The peak saturation calculator 140 determines a peak saturation value sₚₑₐₖ from the histogram calculated by the histogram calculator 130, and the peak gain calculator 150 calculates a peak gain value gₚₑₐₖ from the peak saturation value sₚₑₐₖ. A gain value g to be applied to the pixels is determined by using the peak gain value gₚₑₐₖ, a selectively applicable system gain value gₑₙₕ, and a user gain value gᵤₛₑᵣ which is adjusted by the user. An input pixel signal YCbCr(x,y) is processed with the gain value g to obtain a saturation-adjusted final output signal YCbCrₑₙₕ(x,y).

After the input image signal is stored in the frame memory 110, the saturation calculator 120 calculates the saturation value S(x,y) for each of the pixels input from the frame memory 110. The saturation value S(x,y) is calculated using equations 1 and 2 below, wherein equation 1 is applied to convert the pixel signal YCbCr into an RGB signal to comply with the specifications of ITU-R BT.709-4, and equation 2 is applied to the RGB signal.

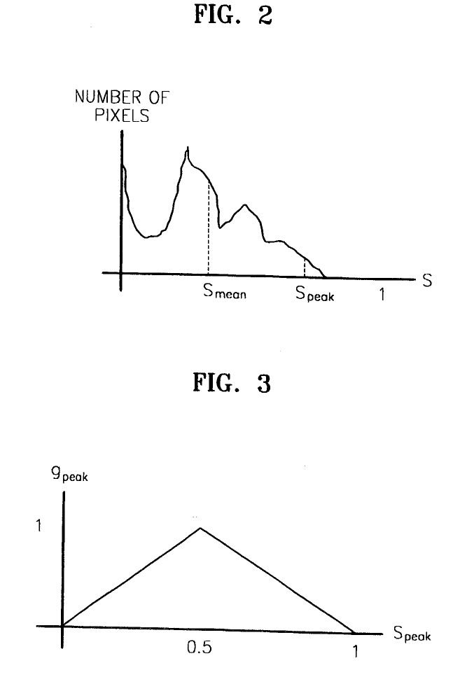

(R,G,B)=(Y+a·Cr, Y+b·Cr+c·Cb, Y+d·Cb) (1)

where a, b, c, and d are conversion coefficients.

$$\begin{matrix}S = \frac{Max [ R , G , B ] - Min [ R , G , B ]}{Max [ R , G , B ] + Min [ R , G , B ]} or \\ S = \frac{Max [ R , G , B ] - Min [ R , G , B ]}{Max [ R , G , B ]}\end{matrix} \qquad ( 2 )$$

where S is a normalized saturation value between 0 and 1. When hardware is designed to set the normalized saturation value S in an integer format of [0, 100], a histogram as shown in FIG. 2 can be obtained by accumulating the saturation values of all of the pixels. If Max for the normalized saturation value S has a very small or a very large value, S is not accumulated considering image noise.

The peak saturation calculator 140 determines a saturation value of the pixels corresponding to 0.5% of the total number of the pixels from the pixel having the largest saturation value, as the peak saturation value sₚₑₐₖ, from the histogram calculated by the histogram calculator 130, as shown in FIG. 2. Here, the limit of 0.5% was determined considering noises of the input image, and can be varied depending on noise levels.

The peak gain calculator 150 determines the peak gain value gₚₑₐₖ using the peak saturation value sₚₑₐₖ determined by the peak saturation calculator 140 and a gain function of FIG. 3. According to the gain function of FIG. 3, a peak gain value gₚₑₐₖ is 0 for a peak saturation value sₚₑₐₖ of 1, linearly increases as the peak saturation value sₚₑₐₖ decreases from 1 to 0.5, and gradually linearly attenuates and converges to zero as the peak saturation value sₚₑₐₖ decreases from 0.5 to 0. Therefore, the gain function of FIG. 3 is effective to reduce an extremely large gain for a gray input image.

The final gain calculator 160 calculates the final gain g for the input image using the peak gain value sₚₑₐₖ calculated by the peak gain calculator 150, the system gain value gₑₙₕ, and the user gain value gᵤₛₑᵣ, as expressed in equation 3:

g=gᵤₛₑᵣ (1+gₑₙₕ·gₚₑₐₖ) (3)

The system gain value gₑₙₕ controls degrees of the color image enhancement. When the system gain value gₑₙₕ is 0, there is no image enhancement effect. The image quality is greatly enhanced by increasing the system gain value gₑₙₕ to more than 1. A general system gain default value is a value between 0.5 and 1 and is determined through a visual test using a number of observers.

The user gain value gᵤₛₑᵣ is similar to a value set by the user on an existing color TV receiver using a saturation adjuster, which is usually indicated by a “color button.” When the user gain value gᵤₛₑᵣ is 0, a gray image is displayed. The saturation of the image is increased by increasing the user gain value gᵤₛₑᵣ to more than 1. A general user gain default value is 1 for standard color image display.

The saturation adjustor 170 outputs the saturation-adjusted signal YCbCrₑₙₕ(x,y) by applying the final gain g calculated by the final gain calculator 160 to the original color signals Cb and Cr of each of the pixels, as expressed in equation 4:

(Y, Cb, Cr)ₑₙₕ(x,y)=(Y(x,y), g·Cb(x,y), g·Cr(x,y)) (4)

Through the saturation adjustment for all of the pixels of one frame in the above-described manner, color enhancement and equalization for the frame are complete.

Although the gain function of FIG. 3 is used in this embodiment, a variety of gain functions having no discontinuity can be applied if necessary.

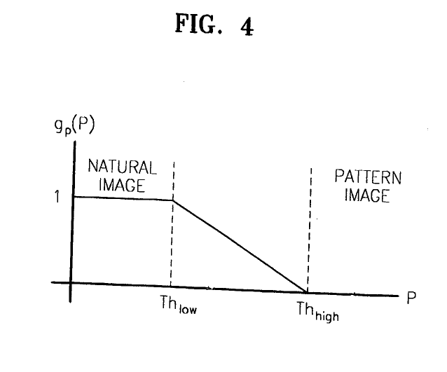

Another embodiment of the present invention will be described below with reference to FIGS. 1 and 4. In this embodiment, the frame memory 110, the saturation calculator 120, the histogram calculator 130, the peak saturation calculator 140, and the peak gain calculator 150 described in the previous embodiment provide the same functions as in the previous embodiment, and thus detailed descriptions thereon will be omitted here.

The peak saturation calculator 140 determines the peak saturation value sₚₑₐₖ from the histogram formed by the histogram calculator 130, as shown in FIG. 2, and the peak gain calculator 150 calculates the peak gain value gₚₑₐₖ using the gain function of FIG. 3.

A pattern gain calculator 180 detects a test pattern image or a monotone image, for example, an image of a bird flying in the sky or an image of a sunset, and calculates a pattern gain value gₚ for the test pattern image or the monotone image. Compared with a general natural image, from the corresponding histograms, the test pattern image and the monotone image have relatively high frequency components. In consideration of the characteristics of the test pattern image and the monotone image, the absolute value of a pixel count difference between adjacent saturation regions is calculated for the entire saturation histogram (i=1, . . . , N−1), and an average of the absolute values for all of the saturation regions is calculated as a P value, as expressed in equation 5:

$$P = \frac{1}{N} {\sum }_{i = 1}^{N - 1} \vert H ( i ) - H ( i + 1 ) \vert \qquad ( 5 )$$

where H(i) denotes the number of the pixels in a saturation region i. The pattern gain value gₚ is calculated using a pattern gain function of FIG. 4 and the P value calculated by using equation 5. In the pattern gain function of FIG. 4, Th_{Low} and Th_{High} vary depending on the normalization of the maximum count in the histogram. When the P value is smaller than Th_{Low}, the input image corresponds to a general natural image (having a continuous histogram). When the P value is greater than Th_{High} (having a discrete histogram), the input image corresponds to a test pattern image. Accordingly, when the input image has a P value corresponding to a general natural image, the pattern gain value gₚ is set to 1. When the input image has a P value corresponding to a test pattern, the pattern gain value gₚ is set to 0 to bypass the saturation adjustment for the original input image.

When the input image has a P value between Th_{Low} and Th_{High}, the input image corresponds to a monotone image. In this case, an excess increase in the saturation of the monotone image degrades picture quality. Accordingly, the pattern gain value gₚ for such a monochrome image is reduced inversely with respect to the P value.

This pattern detection algorithm is resistant to noise and is simple, and thus can be practically applied with reliability. The final gain calculator 160 calculates the final gain g for the input image using the peak gain value gₚₑₐₖ calculated by the peak gain calculator 150, the pattern gain value gₚ calculated by the pattern gain calculator 180, the system gain value gₑₙₕ, and the user gain value gᵤₛₑᵣ, as expressed in equation 6:

g=gᵤₛₑᵣ·(1+gₑₙₕ·gₚ·gₚₑₐₖ) (6)

The saturation adjustor 170 outputs the saturation-adjusted signal YCbCrₑₙₕ(x,y) by applying the final gain g calculated by the final gain calculator 160 to the original color signals Cb and Cr of each of the pixels, which is calculated using equation 4 above.

Through the saturation adjustment for all of the pixels of one frame in the above-described manner, color enhancement and equalization for the frame are complete.

Although the pattern gain function of FIG. 4 is used in the above embodiment, a variety of pattern gain functions having no discontinuity can be applied if necessary.

Another embodiment of the present invention will be described below with reference to FIGS. 1, 5, and 6. In this embodiment, the frame memory 110, the saturation calculator 120, the histogram calculator 130, the peak saturation calculator 140, and the peak gain calculator 150 shown in FIG. 1 and described in the previous embodiment provide the same functions as in the previous embodiment, and thus detailed descriptions thereon will be omitted here.

A color gain calculator 190 calculates a color gain value gₛₖᵢₙ(x,y) depending on whether each pixel of the input image belongs to a skin color region. To determine whether a pixel value input to the color gain calculator 190 belongs to the skin color region, it is necessary to track the position of the skin color region in the YCbCr color space.

In the present invention, a method using an ellipsoidal gain function and a logic “AND” combination method of gain functions for the Y, Cb, Cr signals are suggested to determine whether the input pixel belongs to the skin color region. The two methods can be applied to any color space, for example, RGB, YUV, CIELAB, and CIELUV spaces.

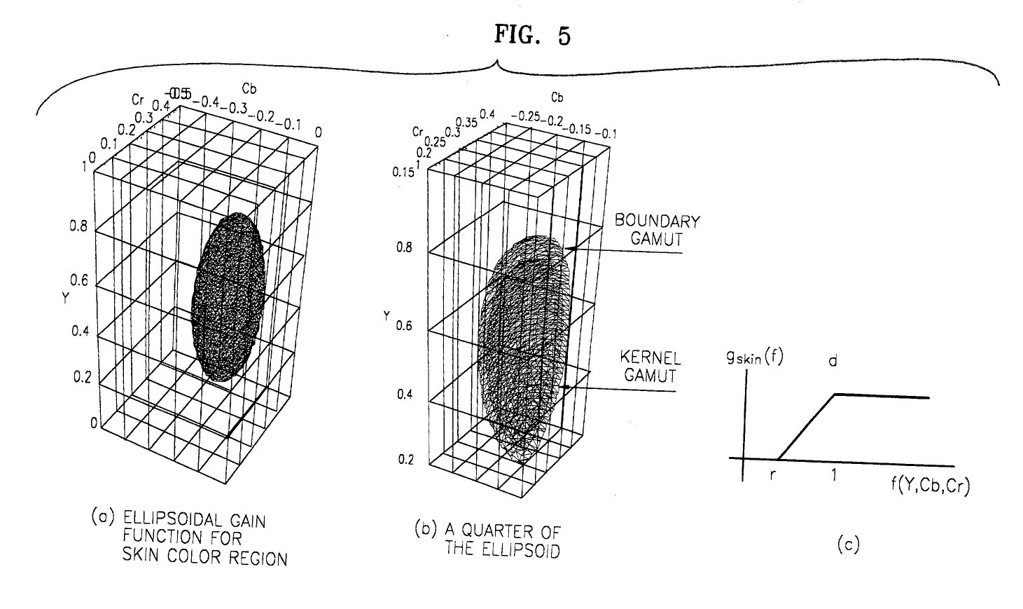

In the method using a 3-D ellipsoidal gain function, as shown in (a) of FIG. 5, a mean color value (Ym, Cbm, Crm) of the skin color region is determined as the center coordinate of the ellipsoid, and race- or system-dependent skin color variations of three axes of the ellipsoidal equation are determined as radii (Yr, Cbr, Crr) of the ellipsoid, which is expressed in equation 7 below:

$$f ( Y , Cb , Cr ) = {( \frac{Y - Ym}{Yr} )}^{2} + {( \frac{Cb - Cbm}{Cbr} )}^{2} + {( \frac{Cr - Crm}{Crr} )}^{2} \qquad ( 7 )$$

The color gain value gₛₖᵢₙ(x,y) for a given pixel is derived using f(Y, Cb, Cr) calculated using equation 7 above. When f(Y, Cb, Cr) for the YCbCr value of the given pixel is smaller than r, the pixel is determined to belong to the skin color region. Especially, a region of the ellipsoid with f(Y, Cb, Cr)=r is called a “kernel gamut,” as shown in (b) of FIG. 5. When f(Y, Cb, Cr) for an input pixel is in the kernel gamut, the input pixel is determined to belong to the skin color region, and the color gain value gₛₖᵢₙ(x,y) is set to 0.

When f(Y, Cb, Cr) for an input pixel is greater than 1, the input pixel is determined not to belong to the skin color region. Especially, a region of the ellipsoid with f(Y, Cb, Cr)=r is called a “boundary gamut,” as shown in (b) of FIG. 5. For a pixel which is beyond the boundary gamut, the color gain value gₛₖᵢₙ(x,y) is set to 1.

When f(Y, Cb, Cr) for an input pixel has a value between the kernel gamut and the boundary gamut, the color gain value gₛₖᵢₙ(x,y) for the input pixel is set to (f(Y, Cb, Cr)−r)/(1−r), based on the linear graph between r and 1 providing continuity between the kernel gamut and the boundary gamut, as shown in (c) of FIG. 5, to consider skin color variations in a source image and to ensure continuity of color in the kernel gamut and the boundary gamut.

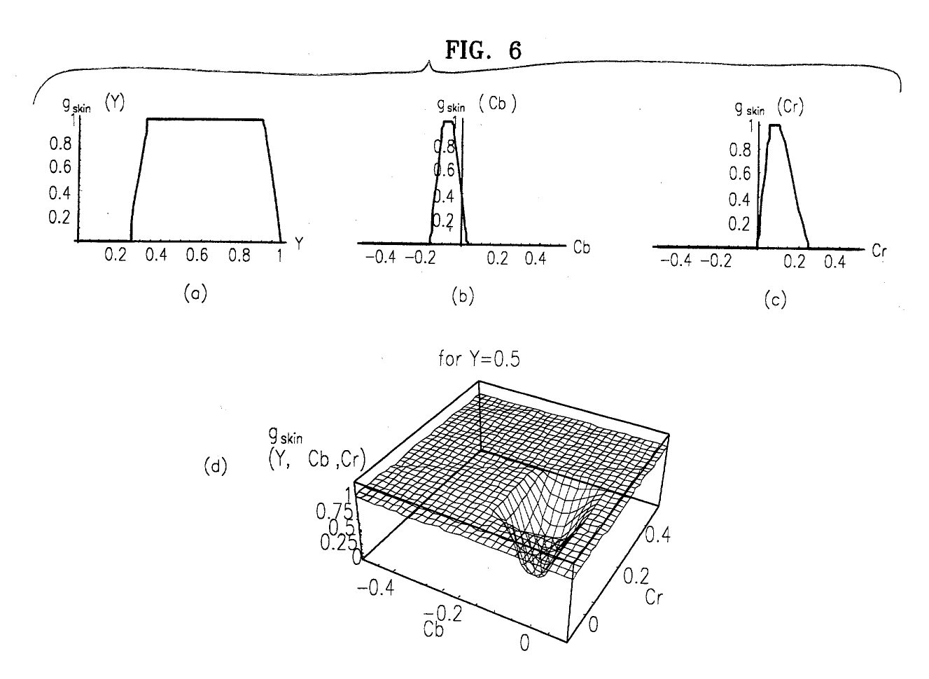

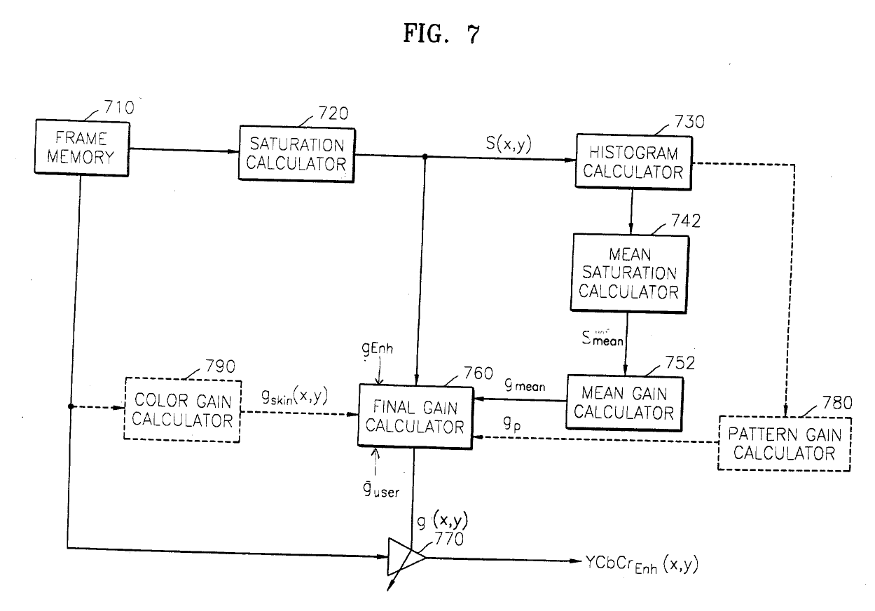

In the other method to determine whether the input image belongs to the skin color region, a skin color gain function for each of the Y, Cb, and Cr signals is defined, as shown in (a), (b), and (c) of FIG. 6, and the three gain functions are combined by a logic AND operation, which are expressed in equation 8 below:

gₛₖᵢₙ(Y,Cb,Cr)=1−[gₛₖᵢₙ(Y)·gₛₖᵢₙ(Cb)·gₛₖᵢₙ(Cr)] (8)

As an example, (d) of FIG. 6 shows the skin color gain function gₛₖᵢₙ(Y,Cb,Cr) for Y=0.5 in the 3-D YCbCr color coordinate system.

The color gain calculator 190 calculates the color gain value gₛₖᵢₙ(x,y) varying according to the color coordinate of the input pixel by using one of the above-described methods.

The final gain calculator 190 calculates a final gain g(x,y) for the input image, which varies according to the color coordinate and saturation of the pixels, using the peak gain value gₚₑₐₖ calculated by the peak gain calculator 150, the color gain value gₛₖᵢₙ(x,y) calculated by the color gain calculator 190, the system gain value gₑₙₕ, and the user gain value gᵤₛₑᵣ, as expressed in equation 9:

g(x,y)=gᵤₛₑᵣ·(1+gₑₙₕ·gₛₖᵢₙ(x,y)·gₚₑₐₖ) (9)

The saturation adjustor 170 outputs the saturation-adjusted signal YCbCrₑₙₕ(x,y) by applying the final gain g(x,y) calculated by the final gain calculator 160 to the original color signals Cb and Cr of each of the pixels, as expressed in equation 10 below:

(Y,Cb,Cr)ₑₙₕ(x,y)=(Y(x,y), g(x,y)·Cb(x,y), g(x,y)·Cr(x,y)) (10)

Through the saturation adjustment for all of the pixels of one frame in the above-described manner, color enhancement and equalization for the frame are complete.

Another embodiment of the present invention will be described with reference to FIGS. 1 through 6. In this embodiment, the frame memory 110, the saturation calculator 120, the histogram calculator 130, the peak saturation calculator 140, the peak gain calculator 150, the pattern gain calculator 180, and the color gain calculator 190 shown in FIG. 1 and described in the previous embodiment provide the same functions as in the previous embodiment, and thus detailed descriptions thereon will be omitted here.

The final gain calculator 160 calculates the final gain g(x,y) for the input image, which varies according to the color coordinate and saturation of the pixels, using the peak gain value gₚₑₐₖ calculated by the peak gain calculator 150, the color gain value gₛₖᵢₙ(x,y) calculated by the color gain calculator 190, the pattern gain value gₚ calculated by the pattern gain calculator 180, the system gain value gₑₙₕ, and the user gain value gᵤₛₑᵣ, as expressed in equation 11:

g(x,y)=gᵤₛₑᵣ(1+gₑₙₕ·gₛₖᵢₙ(x,y)·gₚ·gₚₑₐₖ) (11)

The saturation adjustor 170 outputs the saturation-adjusted signal YCbCrₑₙₕ(x,y) by applying the final gain g(x,y) calculated by the final gain calculator 160 to the original color signals Cb and Cr of each of the pixels, as expressed in equation 10 above.

Another embodiment of the present invention will be described with reference to FIGS. 2, 7, 8A and 8B. A frame memory 710, a saturation calculator 720, and a histogram calculator 730 shown in FIG. 7 provide the same functions as in the previous embodiments described with reference to FIG. 1, and thus detailed descriptions thereon will be omitted here.

A mean saturation calculator 742 calculates a mean saturation value sₘₑₐₙ from the histogram of FIG. 2 obtained by the histogram calculator 730.

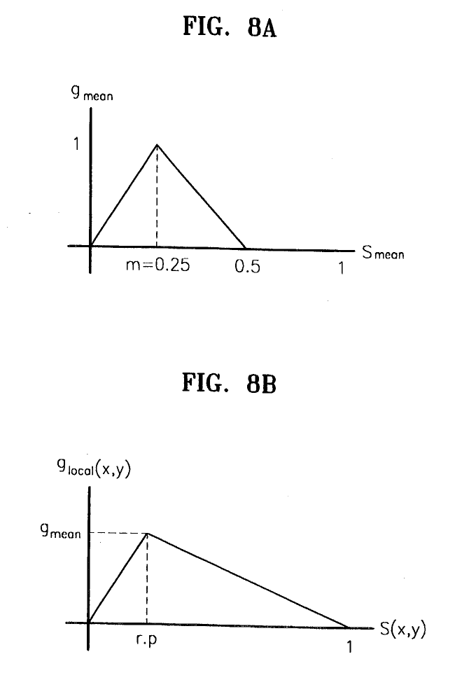

A mean gain calculator 752 calculates a mean gain value gₘₑₐₙ using the mean saturation value sₘₑₐₙ determined by the mean saturation calculator 742 and a gain function from FIG. 8A. According to the gain function of FIG. 8A, when the mean saturation value sₘₑₐₙ of the input image is greater than or equal to 0.5, the mean gain value gₘₑₐₙ is set to 0 to bypass processing on the original image. The mean gain value gₘₑₐₙ is linearly increased as the mean saturation value sₘₑₐₙ decreases from 0.5 to 0.25. The mean gain value gₘₑₐₙ is reduced for a gray image as the mean saturation value sₘₑₐₙ approaches 0 from 0.25.

A final gain calculator 760 calculates a local gain value g_{local}(x,y) for each pixel using the gain function of FIG. 8B obtained from the mean gain value gₘₑₐₙ and the saturation value S(x,y) for the corresponding pixel calculated by the saturation calculator 720. According to the gain function of FIG. 8B, the maximum value at the inflection point is equal to the mean gain value gₘₑₐₙ calculated by the mean gain calculator 752. The gain value g_{local}(x,y) is reduced for a gray image as the saturation value S(x,y) of the pixel approaches 0 from the inflection point (r.p).

As is apparent from the gain function of FIG. 8B, the gain value g_{local}(x,y) for each of the pixels was determined to be smaller for a pixel having a greater saturation value S(x,y), thereby reducing the need for gamut mapping in a conventional image process, which results in an unnatural image having abrupt color variations.

For a rapid calculation of the gain value g_{local}(x,y) for each of the pixels, an additional memory may be used to store the data calculated by the saturation calculator 720 as long as the system size is large enough for the amount of memory.

The final gain calculator 760 calculates a final gain g(x,y) for the input image, which varies according to the color coordinate and saturation of the pixels, using the gain value g_{local}(x,y) calculated by the final gain calculator 760, the system gain value gₑₙₕ, and the user gain value gᵤₛₑᵣ, as expressed in equation 12:

g(x,y)=gᵤₛₑᵣ·(1+gₑₙₕ·g_{local}(x,y)) (12)

A saturation adjustor 770 outputs a saturation-adjusted signal YCbCrₑₙₕ(x,y) by applying the final gain g(x,y) calculated by the final gain calculator 160 to the original color signals Cb and Cr of each of the pixels, as expressed in equation 10 above.

Although the gain functions of FIGS. 8A and 8B are used in the embodiment, a variety of gain functions having no discontinuity can be applied if necessary.

Another embodiment of the present invention will be described below with reference to FIGS. 4, 7, 8A and 8B. In this embodiment, the frame memory 710, the saturation calculator 720, the histogram calculator 730, the mean saturation calculator 742, the mean gain calculator 752, and the pattern gain calculator 780 provide the same functions as in the previous embodiments described with reference to FIGS. 1 and 7, and thus detailed descriptions thereon will be omitted here.

The final gain calculator 760 calculates the final gain g(x,y) for the input image, which varies according to the color coordinate and saturation of the pixels, using the gain value g_{local}(x,y) obtained with the mean gain value gₘₑₐₙ calculated by the mean gain calculator 752, the pattern gain value gₚ calculated by the gain pattern calculator 780, the system gain value gₑₙₕ, and the user gain value gᵤₛₑᵣ, as expressed in equation 13:

g(x,y)=gᵤₛₑᵣ·(1+gₑₙₕ·gₚ·g_{local}(x,y)) (13)

The saturation adjustor 770 outputs a saturation-adjusted signal YCbCrₑₙₕ(x,y) by applying the final gain g(x,y) calculated by the final gain calculator 760 to the original color signals Cb and Cr of each of the pixels, as expressed in equation 10 above.

Another embodiment of the present invention will be described below with reference to FIGS. 5, 6, and 8A and 8B. In this embodiment, the frame memory 710, the saturation calculator 720, the histogram calculator 730, the mean saturation calculator 742, the mean gain calculator 752, and the color gain calculator 790 provide the same functions as those in the previous embodiments described with reference to FIGS. 1 and 7, and thus detailed descriptions thereon will be omitted here.

The final gain calculator 760 calculates the final gain g(x,y) for the input image, which varies according to the color coordinate and saturation of the pixels, using the gain value g_{local}(x,y) obtained with the mean gain value gₘₑₐₙ calculated by the mean gain calculator 752, the color gain value gₛₖᵢₙ(x,y) calculated by the color gain calculator 790, the system gain value gₑₙₕ, and the user gain value gᵤₛₑᵣ, as expressed in equation 14:

g(x,y)=gᵤₛₑᵣ·(1+gₑₙₕ·gₛₖᵢₙ(x,y)·g_{local}(x,y)) (14)

The saturation adjustor 770 outputs the saturation-adjusted signal YCbCrₑₙₕ(x,y) by applying the final gain g(x,y) calculated by the final gain calculator 760 to the original color signals Cb and Cr of each of the pixels, as expressed in equation 10 above.

Another embodiment of the present invention will be described below with reference to FIG. 7. In this embodiment, the frame memory 710, the saturation calculator 720, the histogram calculator 730, the mean saturation calculator 742, the mean gain calculator 752, the mean gain calculator 780, and the color gain calculator 790 provide the same functions as in the previous embodiments, and thus detailed descriptions thereon will be omitted here.

The final gain calculator 760 calculates the final gain g(x,y) for the input image, which varies according to the color coordinate and saturation of the pixel, using the gain value g_{local}(x,y) obtained with the mean gain value gₘₑₐₙ calculated by the mean gain calculator 752, the pattern gain value gₚ calculated by the pattern gain calculator 780, the color gain value gₛₖᵢₙ(x,y) calculated by the color gain calculator 790, the system gain value gₑₙₕ, and the user gain value gᵤₛₑᵣ, as expressed in equation 15:

g(x,y)=gᵤₛₑᵣ(1+gₑₙₕ·gₛₖᵢₙ(x,y)·gₚ·g_{local}(x,y)) (15)

The saturation adjustor 770 outputs a saturation-adjusted signal YCbCrₑₙₕ(x,y) by applying the final gain g(x,y) calculated by the final gain calculator 760 to the original color signals Cb and Cr of each of the pixels, as expressed in equation 10 above.

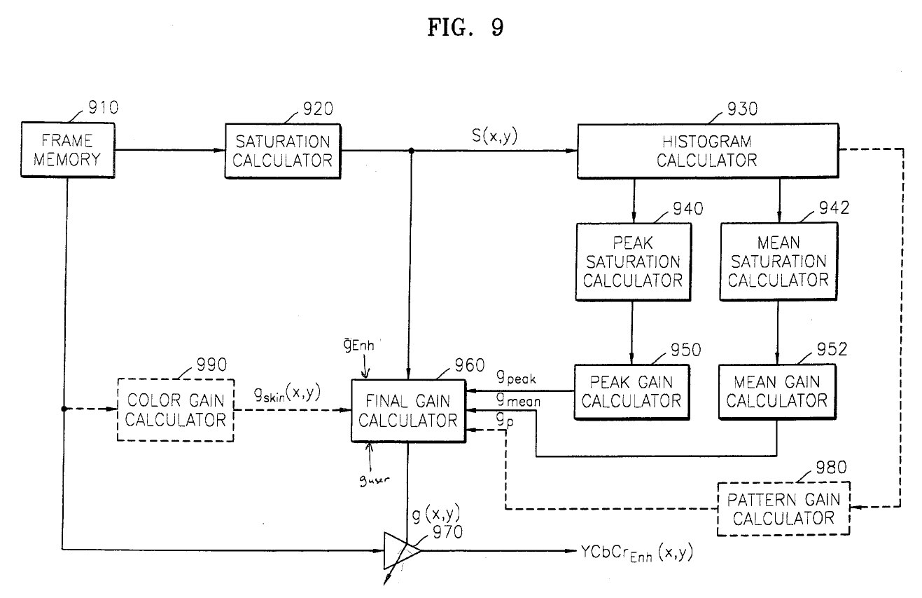

FIG. 9 shows a saturation adjusting apparatus according to another embodiment of the present invention. A frame memory 910, a saturation calculator 920, a histogram calculator 930, a peak saturation calculator 940, a peak gain calculator 950, a mean saturation calculator 942, and a mean gain calculator 952 provide the same function as those in the previous embodiments described with reference to FIGS. 1 and 7, and thus detailed descriptions thereon will be omitted here.

The final gain calculator 960 calculates a final gain g(x,y) for the input image, which varies according to the color coordinate and saturation of the pixels, using the peak gain value gₚₑₐₖ determined by the peak gain calculator 950, the local gain value g_{local}(x,y) obtained with the mean gain value gₘₑₐₙ calculated by the mean gain calculator 952, the system gain value gₑₙₕ, and the user gain value gᵤₛₑᵣ, as expressed in equation 16:

g(x,y)=gᵤₛₑᵣ·(1+gₑₙₕ(gₚₑₐₖ+g_{local}(x,y)) (16)

The saturation adjustor 970 outputs a saturation-adjusted signal YCbCrₑₙₕ(x,y) by applying the final gain g(x,y) calculated by the final gain calculator 760 to the original color signals Cb and Cr of each of the pixels, as expressed in equation 10 above.

Alternately, the final gain calculator 960 calculates the final gain g(x,y) for the input image, which varies according to the color coordinate and saturation of the pixels, using the peak gain value gₚₑₐₖ determined by the peak gain calculator 950, the local gain value g_{local}(x,y) obtained with the mean gain value gₘₑₐₙ calculated by the mean gain calculator 952, the gain pattern value gₚ calculated by the pattern gain calculator 980, the system gain value gₑₙₕ, and the user gain value gᵤₛₑᵣ as expressed in equation 17:

g(x,y)=gᵤₛₑᵣ·(1+gₑₙₕ·gₚ·(gₚₑₐₖ+g_{local}(x,y))) (17)

The saturation adjustor 970 outputs a saturation-adjusted signal YCbCrₑₙₕ(x,y) by applying the final gain g(x,y) calculated by the final gain calculator 760 to the original color signals Cb and Cr of each of the pixels, as expressed in equation 10 above.

Another embodiment of the present invention will be described below with reference to FIG. 9. In this embodiment, the frame memory 910, the saturation calculator 920, the histogram calculator 930, the peak saturation calculator 940, the peak gain calculator 950, the mean saturation calculator 942, the average gain calculator 952, and the color gain calculator 990 provide the same functions as in the previous embodiments described with reference to FIGS. 1 and 7.

The final gain calculator 960 calculates the final gain g(x,y) for the input image, which varies according to the color coordinate and saturation of the pixels, using the peak gain value gₚₑₐₖ determined by the peak gain calculator 950, the local gain value g_{local}(x,y) obtained with the mean gain value gₘₑₐₙ calculated by the mean gain calculator 952, the color gain value gₛₖᵢₙ(x,y) calculated by the color gain calculator 990, the system gain value gₑₙₕ, and the user gain value gᵤₛₑᵣ, as expressed in equation 18:

g(x,y)=gᵤₛₑᵣ·(1+gₑₙₕ·gₛₖᵢₙ(x,y)·(gₚₑₐₖ+g_{local}(x,y))) (18)

The saturation adjustor 970 outputs the saturation-adjusted signal YCbCrₑₙₕ(x,y) by applying the final gain g(x,y) calculated by the final gain calculator 760 to the original color signals Cb and Cr of each of the pixels, as expressed in equation 10 above.

Another embodiment of the present invention will be described below with reference to FIG. 9. In this embodiment, the frame memory 910, the saturation calculator 920, the histogram calculator 930, the peak saturation calculator 940, the peak gain calculator 950, the mean saturation calculator 942, the mean gain calculator 952, the pattern gain calculator 980, and the color gain calculator 990 provide the same functions as in the previous embodiments described with reference to FIGS. 1 and 7, and thus detailed descriptions thereon will be omitted here.

The final gain calculator 960 calculates the final gain g(x,y) for the input image, which varies according to the color coordinate and saturation of the pixels, using the peak gain value gₚₑₐₖ determined by the peak gain calculator 950, the local gain value g_{local}(x,y) obtained with the mean gain value gₘₑₐₙ calculated by the mean gain calculator 952, the color gain value gₛₖᵢₙ(x,y) calculated by the color gain calculator 990, the pattern gain value gₚ calculated by the pattern gain calculator 980, the system gain value gₑₙₕ, and the user gain value gᵤₛₑᵣ, as expressed in equation 19:

g(x,y)=gᵤₛₑᵣ·(1+gₑₙₕ·gₚ·gₛₖᵢₙ(x,y)·(gₚₑₐₖ+g_{local}(x,y))) (19)

The saturation adjustor 970 outputs a saturation-adjusted signal YCbCrₑₙₕ(x,y) by applying the final gain g(x,y) calculated by the final gain calculator 760 to the original color signals Cb and Cr of each of the pixels, as expressed in equation 10 above.

As described above, according to the described embodiments of the present invention, the saturation of an output image can be adaptively adjusted using information extracted from an input image, thereby enhancing the quality of the image.

In particular, peak saturation and mean saturation values of the input image are detected and used to correct for the saturation of the input image. When the input image is a quality, high-saturation image, processing on the input image is bypassed. When the input image has a low saturation value, the saturation of, for example, the entire image or a particular color region of the image can be increased for quality enhancement. Also, saturation variations between frames of a moving picture displayed on hardware, which may occur during data transmission, or between TV channels, can be automatically equalized to maintain a constant saturation level.

In addition, the saturation adjusting apparatus according to the present invention detects a test pattern image to bypass saturation adjustment on the test pattern image, and controls the quality of the test pattern image displayed on a display apparatus. It is also determined whether an input pixel belongs to a skin color region, and the saturation adjustment is performed only on the other color region, such as a background image, to suppress an excess increase in the saturation of the skin color.

A gain value obtained from the input image information is applied only to the color signals Cb and Cr of the image to selectively adjust the saturation of the input image while the brightness of the input image is maintained. Since the gain value is calculated in consideration of the saturation value of each pixel, an unnecessary gamut-mapping block can be eliminated to prevent saturation distortion and to construct simple system hardware. A gain value for a gray image is adaptively reduced to maintain gray balance.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An apparatus to adjust a saturation of a color image, comprising:
a saturation calculator which calculates a saturation value for each of a plurality of pixels of an input image;
a peak saturation calculator which determines a peak saturation value of the input image using the saturation values calculated by the saturation calculator;
a peak gain calculator which calculates a peak gain value based on the peak saturation value determined by the peak saturation calculator; and
a saturation adjustor which adaptively adjusts a saturation of the input image using the peak gain value calculated by the peak gain calculator.

2. The apparatus of claim 1, further comprising a histogram calculator which calculates a saturation histogram of the input image using the saturation values calculated by the saturation calculator, wherein the peak saturation calculator determines the peak saturation value from the saturation histogram calculated by the histogram calculator.

3. The apparatus of claim 1, wherein the saturation calculator converts an input image signal into an RGB signal and calculates the saturation values for each of the pixels as a ratio of a difference between maximum and minimum values of the RGB signal to the sum of the maximum and minimum values of the RGB signal.

4. The apparatus of claim 3, wherein the input image signal input to the saturation calculator is a YCbCr, YUV, or YIQ signal.

5. The apparatus of claim 2, wherein the saturation calculator converts an input image signal into an RGB signal and calculates the saturation values for each of the pixels as a ration of a difference between maximum and minimum value of the RGB signal to the sum of the maximum and minimum values of the RGB signal when the maximum value of the RGB signal for the input image signal processed by the saturation calculator is less than a first predetermined value or is greater than or equal to a second predetermined value, and the maximum value of the input image signal is not accumulated to calculate the saturation histogram.

6. The apparatus of claim 1, further comprising:
a mean saturation calculator which calculates a mean saturation value of the input image using the saturation values calculated by the saturation calculator; and
a mean gain calculator which calculates a mean gain value based on the mean saturation value calculated by the mean saturation calculator,
wherein the saturation adjustor calculates a local gain value for each of the pixels using the mean gain value calculated by the mean gain calculator and the saturation values calculated by the saturation calculator and adaptively adjusts the saturation of each of the pixels of the input image using the local gain value and the peak gain value.

7. The apparatus of claim 1, wherein the peak gain calculator calculates the peak gain value when the peak saturation value is less than or equal to a first saturation value and when the peak gain value is greater than or equal to a second saturation value, wherein the second saturation value is greater than the first saturation value, and the calculated peak gain value is less than the peak gain value when the peak saturation value is between the first and second saturation values.

8. The apparatus of claim 1, wherein the peak saturation calculator determines the saturation values of the pixels corresponding to a predetermined percentage of the pixels from the pixel having a largest saturation value, as the peak saturation value.

9. The apparatus of claim 1, wherein the saturation adjustor adaptively adjusts the saturation of the input image with respect to a system gain value or a user gain value.

10. An apparatus to adjust a saturation of a color image, comprising:
a saturation calculator which calculates a saturation value for each of a plurality of pixels of an input image;
a peak saturation calculator which determines a peak saturation value of the input image using the saturation values calculated by the saturation calculator;
a peak gain calculator which calculates a peak gain value based on the peak saturation value determined by the peak saturation calculator;
a pattern gain calculator which determines whether the input image is a predetermined pattern image and calculates a pattern gain value for the predetermined pattern image depending on whether the input image is determined to be the predetermined pattern image; and
a saturation adjustor which adaptively adjusts a saturation of the input image using the peak gain value calculated by the peak gain calculator and the pattern gain value calculated by the pattern gain calculator.

11. The apparatus of claim 10, wherein the predetermined pattern image is a test pattern image.

12. The apparatus of claim 10, wherein the pattern gain calculator calculates an absolute value of a pixel count difference between adjacent saturation regions of the input image and an average of the calculated absolute values for all of the saturation regions of the input image and calculates the pattern gain value using the calculated average of the absolute values.

13. The apparatus of claim 10, further comprising:
a mean saturation calculator which calculates a mean saturation value of the input image using the saturation values calculated by the saturation calculator; and
a mean gain calculator which calculates a mean gain value based on the mean saturation value calculated by the mean saturation calculator,
wherein the saturation adjustor calculates a local gain value for each of the pixels using the mean gain value calculated by the mean gain calculator and the saturation values calculated by the saturation calculator and adaptively adjusts the saturation of each of the pixels of the input image using the local gain value and the peak gain value.

14. The apparatus of claim 10, wherein the peak gain calculator calculates a peak gain value when the peak saturation value is less than or equal to a first saturation value and when the peak gain value is greater than or equal to a second saturation value, wherein the second saturation value is greater than the first saturation value, and the calculated peak gain value is less than the peak gain value when the peak saturation value is between the first and second saturation values.

15. The apparatus of claim 10, wherein the peak saturation calculator determines the saturation values of the pixels corresponding to a predetermined percentage of the pixels from the pixel having a largest saturation value, as the peak saturation value.

16. The apparatus of claim 10, wherein the saturation adjustor adaptively adjusts the saturation of the input image with respect to a system gain value or a user gain value.

17. An apparatus to adjust a saturation of a color image, comprising:
a saturation calculator which calculates a saturation value for each of a plurality of pixels of an input image;
a peak saturation calculator which determines a peak saturation value of the input image using the saturation values calculated by the saturation calculator;
a peak gain calculator which calculates a peak gain value based on the peak saturation value determined by the peak saturation calculator;
a color gain calculator which determines whether each of the pixels of the input image belongs to a color region of the input image and calculates a color gain value for the pixels depending on whether the pixels belong to the predetermined color region; and
a saturation adjustor which adaptively adjusts the saturation for each of the pixels of the input image using the peak gain value calculated by the peak gain calculator and the color gain value calculated by the color gain calculator.

18. The apparatus of claim 17, further comprising a pattern gain calculator which determines whether the input image is a predetermined pattern image and calculates a pattern gain value depending on whether the input image is determined to be the predetermined pattern image, wherein the saturation adjustor adaptively adjusts the saturation for each of the pixels of the input image in consideration of the pattern gain value.

19. The apparatus of claim 18, wherein the predetermined pattern image is a test pattern image.

20. The apparatus of claim 18, wherein the pattern gain calculator calculates an absolute value of a pixel count difference between adjacent saturation regions of the input image and an average of the calculated absolute values for all of the saturation regions of the input image and calculates the pattern gain value using the calculated average of the absolute values.

21. The apparatus of claim 20, wherein the pattern gain calculator determines the input image as the predetermined pattern image if an average of the absolute values is greater than a first threshold, determines the input image as a natural image if the average of the absolute values is smaller than a second threshold, and outputs the pattern gain value corresponding to the input image.

22. The apparatus of claim 18, wherein the color region is a skin color region.

23. The apparatus of claim 22, wherein the color gain calculator determines whether an input one of the pixels belongs to the skin color region by using a 3-dimensional ellipsoidal equation having a mean color value of the skin color region as a center coordinate of an ellipsoid and race- or system-dependent skin color variations as radii of three axes of the ellipsoid, and outputs the color gain value according to the determination.

24. The apparatus of claim 18, wherein the color gain calculator determines whether an input one of the pixels belongs to the color region by using gain functions for Y, Cb, and Cr values of the input pixel and calculates the color gain value for a YCbCr value of the input pixel.

25. The apparatus of claim 17, further comprising:
a mean saturation calculator which calculates a mean saturation value of the input image using the saturation values calculated by the saturation calculator; and
a mean gain calculator which calculates a mean gain value based on the mean saturation value calculated by the mean saturation calculator,
wherein the saturation adjustor calculates a local gain value for each of the pixels using the mean gain value calculated by the mean gain calculator and the saturation values calculated by the saturation calculator and adaptively adjusts the saturation of each of the pixels of the input image using the local gain value and the peak gain value.

26. The apparatus of claim 25, wherein the mean gain calculator calculates a mean gain value when the mean saturation value is less than or equal to a first saturation value and when the mean saturation value is greater than or equal to a second saturation value, wherein the second saturation value is greater than the first saturation value, and the calculated mean gain value is less than the mean gain value when the mean saturation value is between the first and second saturation values.

27. The apparatus of claim 25, wherein the saturation adjustor calculates a local gain value when the saturation value is less than or equal to a first saturation value and when the saturation value is greater than or equal to a second saturation value, wherein the second saturation value is greater than the first saturation value, and the calculated local gain value is less than the local gain value when the saturation value is between the first and second saturation values.

28. The apparatus of claim 17, wherein the peak gain calculator calculates the peak gain value when the peak saturation value is less than or equal to a first saturation value and when the peak gain value is greater than or equal to a second saturation value, wherein the second saturation value is greater than the first saturation value, and the calculated peak gain value is less than the peak gain value when the peak saturation value is between the first and second saturation values.

29. The apparatus of claim 17, wherein the peak saturation calculator determines the saturation values of the pixels corresponding to a percentage of the pixels from the pixels having a largest saturation value, as the peak saturation value.

30. The apparatus of claim 17, further comprising a histogram calculator which calculates a saturation histogram of the input image using the saturation values calculated by the saturation calculator, wherein the peak saturation calculator determines the peak saturation value from the saturation histogram calculated by the histogram calculator.

31. The apparatus of claim 30, wherein the histogram calculator selectively calculates a saturation histogram for an entire frame of the input image or a saturation histogram for the pixels in a window region of the input image.

32. The apparatus of claim 17, wherein the saturation adjustor adaptively adjusts the saturation of the input image with respect to a system gain value or a user gain value.

33. An apparatus to adjust a saturation of a color image, comprising:
a saturation calculator which calculates a saturation value for each of a plurality of pixels of an input image;
a mean saturation calculator which calculates a mean saturation value of the input image using the saturation values calculated by the saturation calculator;
a mean gain calculator which calculates a mean gain value based on the mean saturation value calculated by the mean saturation calculator; and
a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value.

34. The apparatus of claim 33, further comprising a histogram calculator which calculates a saturation histogram of the input image using the saturation values calculated by the saturation calculator, wherein the mean saturation calculator calculates the mean saturation value from the saturation histogram calculated by the histogram calculator.

35. The apparatus of claim 33, wherein the saturation calculator converts an input image signal into an RGB signal and calculates the saturation for each of the pixels as a ratio of a difference between a maximum and a minimum value of the RGB signal to the sum of the maximum and minimum values of the RGB signal.

36. The apparatus of claim 33, wherein the mean gain calculator calculates the mean gain value when the mean saturation value is less than or equal to a first saturation value and when the mean saturation value is greater than or equal to a second saturation value, wherein the second saturation value is greater than the first saturation value, and the calculated mean gain value is less than the mean gain value when the mean saturation value is between the first and second saturation values.

37. The apparatus of claim 33, wherein the saturation adjustor calculates the local gain value when the saturation value is less than or equal to a first saturation value and when the saturation value is greater than or equal to a second saturation value, wherein the second saturation value is greater than the first saturation value, and the calculated local gain value is less than the local gain value when the saturation value is between the first and second saturation values.

38. The apparatus of claim 33, wherein the saturation adjustor adaptively adjusts the saturation of the input image further with respect to a system gain value or a user gain value.

39. The apparatus of claim 35, wherein the input image signal input to the saturation calculator is a YCbCr, a YUV, or a YIQ signal.

40. The apparatus of claim 35, further comprising a histogram calculator which calculates a saturation histogram of the input image using the saturation values calculated by the saturation calculator, wherein when the maximum value of the RGB signal for the input image signal processed by the saturation calculator is less than a first predetermined value or is greater than or equal to a second predetermined value, the maximum value of the input image signal is not accumulated to calculate the saturation histogram.

41. An apparatus to adjust a saturation of a color image, comprising:
a saturation calculator which calculates a saturation value for each of a plurality of pixels of an input image;
a mean saturation calculator which calculates a mean saturation value of the input image using the saturation values calculated by the saturation calculator;
a mean gain calculator which calculates a mean gain value based on the mean saturation value calculated by the mean saturation calculator;
a pattern gain calculator which determines whether the input image is a predetermined pattern image and calculates a pattern gain value depending on whether the input image is determined as the predetermined pattern image; and
a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value and the pattern gain value calculated by the pattern gain calculator.

42. The apparatus of claim 41, wherein the predetermined pattern image is a test pattern image.

43. The apparatus of claim 41, wherein the pattern gain calculator calculates an absolute value of a pixel count difference between adjacent saturation regions of the input image and an average of the calculated absolute values for all of the saturation regions of the input image and calculates the pattern gain value using the average of the absolute values.

44. The apparatus of claim 41, wherein the mean gain calculator calculates a mean gain value when the mean saturation value is less than or equal to a first saturation value and when the mean saturation value is greater than or equal to a second saturation value, wherein the second saturation value is greater than the first saturation value, and the calculated mean gain value is less than a mean gain value when the mean saturation value is between the first and second saturation values.

45. The apparatus of claim 41, wherein the saturation adjustor calculates the local gain value when the saturation value is less than or equal to a first saturation value and when the saturation value is greater than or equal to a second saturation value, wherein the second saturation value is greater than the first saturation value, and the calculated local gain value is less than the local gain value when the saturation value is between the first and second saturation values.

46. The apparatus of claim 41, further comprising a histogram calculator which calculates a saturation histogram of the input image using the saturation values calculated by the saturation calculator, wherein the mean saturation calculator calculates the mean saturation value from the saturation histogram calculated by the histogram calculator.

47. The apparatus of claim 41, wherein the saturation adjustor adaptively adjusts the saturation of the input image with respect to a system gain value or a user gain value.

48. An apparatus to adjust a saturation of a color image, comprising:
a saturation calculator which calculates a saturation value for each of a plurality of pixels of an input image;
a mean saturation calculator which calculates a mean saturation value of the input image using the saturation values calculated by the saturation calculator;
a mean gain calculator which calculates a mean gain value based on the mean saturation value calculated by the mean saturation calculator;
a color gain calculator which determines whether each of the pixels of the input image belongs to a color region of the input image and calculates a color gain value for the pixels depending on whether the pixels belong to the color region; and
a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value and the color gain value calculated by the color gain calculator.

49. The apparatus of claim 48, further comprising a pattern gain calculator which determines whether the input image is a predetermined pattern image and calculates a pattern gain value depending on whether the input image is determined to be the predetermined pattern image, wherein the saturation adjustor adaptively adjusts the saturation for each of the pixels of the input image with respect to the pattern gain value.

50. The apparatus of claim 49, wherein the predetermined pattern image is a test pattern image.

51. The apparatus of claim 49, wherein the pattern gain calculator calculates an absolute value of a pixel count difference between adjacent saturation regions of the input image and an average of the calculated absolute values for all of the saturation regions of the input image and calculates the pattern gain value using the average of the absolute values.

52. The apparatus of claim 51, wherein the pattern gain calculator determines the input image is the predetermined pattern image if the average of the absolute values is greater than a first threshold, determines the input image is a natural image if the average of the absolute values is less than a second threshold, and outputs the pattern gain value corresponding to the input image.

53. The apparatus of claim 48, wherein the color region is a skin color region.

54. The apparatus of claim 53, wherein the color gain calculator determines whether an input one of the pixels belongs to the skin color region by using a 3-dimensional ellipsoidal equation having a mean color value of the skin color region as a center coordinate of the ellipsoid and race- or system-dependent skin color variations as radii of three axes of the ellipsoid, and outputs the color gain value according to the determination.

55. The apparatus of claim 48, wherein the color gain calculator determines whether an input one of the pixels belongs to the color region by using gain functions for Y, Cb, and Cr values of the input pixel and calculates a color gain value for a YCbCr value of the input pixel.

56. The apparatus of claim 48, wherein the mean gain calculator calculates the mean gain value when the mean saturation value is less than or equal to a first saturation value, and when the mean saturation value is greater than or equal to a second saturation value, wherein the second saturation value is greater than the first saturation value, and the calculated mean gain value is less than the mean gain value when the mean saturation value is between the first and second saturation values.

57. The apparatus of claim 48, wherein the saturation adjustor calculates the local gain value when the saturation value is less than or equal to a first saturation value and when the saturation value is greater than or equal to a second saturation value, wherein the second saturation value is greater than the first saturation value, and the calculated local gain value is less than the local gain value when the saturation value is between the first and second saturation values.

58. The apparatus of claim 57, wherein a largest local gain value for the pixels is equal to the mean gain value calculated by the mean gain calculator.

59. The apparatus of claim 48, further comprising a histogram calculator which calculates a saturation histogram of the input image using the saturation values calculated by the saturation calculator, wherein the mean saturation calculator calculates the mean saturation value from the saturation histogram calculated by the histogram calculator.

60. The apparatus of claim 59, wherein the histogram calculator selectively calculates the saturation histogram for an entire frame of the input image or the saturation histogram for the pixels in a window region of the input image.

61. The apparatus of claim 48, wherein the saturation adjustor adaptively adjusts the saturation of the input image with respect to a system gain value or a user gain value.

62. An apparatus to adjust a saturation of a color image, comprising:
a saturation calculator which calculates a saturation value for each of a plurality of pixels of an input image;
a peak saturation calculator which determines a peak saturation value of the input image using the saturation values calculated by the saturation calculator;
a peak gain calculator which calculates a peak gain value based on the peak saturation value determined by the peak saturation calculator;
a pattern gain calculator which determines whether the input image is a predetermined pattern image and calculates a pattern gain value depending on whether the input image is determined to be the predetermined pattern image;
a color gain calculator which determines whether each of the pixels of the input image belongs to a color region of the input image and calculates a color gain value for the pixels depending on whether the pixels belong to the color region; and
a saturation adjustor which adaptively adjusts the saturation of each of the pixels of the input image using the peak gain value calculated by the peak gain calculator, the pattern gain value calculated by the pattern gain calculator, and the color gain value calculated by the color gain calculator.

63. The apparatus of claim 62, wherein the predetermined pattern image is a test pattern image.

64. The apparatus of claim 62, wherein the color region is a skin color region.

65. The apparatus of claim 62, wherein the saturation adjustor adaptively adjusts the saturation of the input image with respect to a system gain value or a user gain value.

66. An apparatus to adjust a saturation of a color image, comprising:
a saturation calculator which calculates a saturation value for each of a plurality of pixels of an input image;
a mean saturation calculator which calculates a mean saturation value of the input image using the saturation values calculated by the saturation calculator;
a mean gain calculator which calculates a mean gain value based on the mean saturation value calculated by the mean saturation calculator;
a pattern gain calculator which determines whether the input image is a predetermined pattern image and calculates a pattern gain value depending on whether the input image is determined to be the predetermined pattern image;
a color gain calculator which determines whether each of the pixels of the input image belongs to a color region of the input image and calculates a color gain value for the pixels depending on whether the pixels belong to the predetermined color region; and
a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value, the pattern gain value calculated by the pattern gain calculator, and the color gain value calculated by the color gain calculator.

67. The apparatus of claim 66, wherein the predetermined pattern image is a test pattern image.

68. The apparatus of claim 66, wherein the color region is a skin color region.

69. The apparatus of claim 66, wherein the saturation adjustor adaptively adjusts the saturation of the input image with respect to a system gain value or a user gain value.

70. An apparatus to adjust a saturation of a color image, comprising:
a saturation calculator which calculates a saturation value for each of a plurality of pixels of an input image;
a peak saturation calculator which determines a peak saturation value of the input image using the saturation values calculated by the saturation calculator;
a peak gain calculator which calculates a peak gain value based on the peak saturation value determined by the peak saturation calculator;
a mean saturation calculator which calculates a mean saturation value of the input image using the saturation values calculated by the saturation calculator;
a mean gain calculator which calculates a mean gain value based on the mean saturation value calculated by the mean saturation calculator;
a pattern gain calculator which determines whether the input image is a predetermined pattern image and calculates a pattern gain value depending on whether the input image is determined to be the predetermined pattern image;
a color gain calculator which determines whether each of the pixels of the input image belongs to a color region of the input image and calculates a color gain value for the pixels depending on whether the pixels belong to the predetermined color region; and
a saturation adjustor which calculates a local gain value for each of the pixels using the mean gain value calculated by the mean gain calculator and the saturation values calculated by the saturation calculator and adaptively adjusts the saturation of each of the pixels of the input image using the local gain value, the peak gain value calculated by the peak gain calculator, the pattern gain value calculated by the pattern gain calculator, and the color gain value calculated by the color gain calculator.

71. The apparatus of claim 70, wherein the predetermined pattern image is a test pattern image.

72. The apparatus of claim 70, wherein the color region is a skin color region.

73. The apparatus of claim 70, wherein the saturation adjustor adaptively adjusts the saturation of the input image with respect to a system gain value or a user gain value.

74. A display comprising the apparatus to adjust the saturation of the color image according to claim 1.

75. A display comprising the apparatus to adjust a saturation of a color image according to claim 6.

76. A display comprising the apparatus to adjust a saturation of a color image according to claim 23.

77. A display comprising the apparatus to adjust a saturation of a color image according to claim 28.

78. A display comprising the apparatus to adjust a saturation of a color image according to claim 43.

79. The display of claim 74, wherein the display is a digital TV, a digital camera, or a camcoder.

80. The display of claim 76, wherein the display is a digital TV, a digital camera, or a camcoder.

81. The display of claim 78, wherein the display is a digital TV, a digital camera, or a camcoder.

82. An image processor comprising the apparatus to adjust a saturation of a color image according to claim 1.

83. An image processor comprising the apparatus to adjust a saturation of a color image according to claim 23.

84. An image processor comprising the apparatus to adjust a saturation of a color image according to claim 43.

85. A method of adjusting a saturation of a color image, comprising:
calculating a saturation value for each of a plurality of pixels of an input image;
determining a peak saturation value of the input image using the calculated saturation values;
calculating a peak gain value based on the determined peak saturation value; and
adaptively adjusting the saturation of the input image using the calculated peak gain value.

86. The method of claim 85, wherein the peak gain value is lower, when the peak saturation value is less than or equal to a first saturation value and is greater than or equal to a second saturation value, wherein the second saturation value is greater than the first saturation value, than when the peak saturation value is between the first and second saturation values.

87. The method of claim 85, wherein the saturation value of the pixels corresponding to a predetermined percentage of the total number of pixels from the pixel having a largest saturation value is determined as the peak saturation value.

88. The method of claim 85, further comprising:
calculating a mean saturation value of the input image using the calculated saturation values; and
calculating a mean gain value based on the calculated mean saturation value,
wherein the adaptively adjusting comprises calculating a local gain value for each of the pixels using the calculated mean gain value and adaptively adjusting the calculated saturation values and the saturation of each of the pixels of the input image with respect to the local gain value.

89. The method of claim 85, further comprising calculating a saturation histogram of the input image using the calculated saturation values, wherein the peak saturation value is determined from the calculated saturation histogram.

90. The method of claim 85, wherein the adaptively adjusting comprises adaptively adjusting the saturation of the input image with respect to a system gain value or a user gain value.

91. A method of adjusting a saturation of a color image, comprising:
calculating a saturation value for each of a plurality of pixels of an input image;
determining a peak saturation value of the input image using the calculated saturation values;
calculating a peak gain value based on the determined peak saturation value;
determining whether the input image is a predetermined pattern image and calculating a pattern gain value depending on whether the input image is determined to be the predetermined pattern image; and
adaptively adjusting the saturation of the input image using the calculated peak gain value and the calculated pattern gain value.

92. The method of claim 91, wherein the predetermined pattern image is a test pattern image.

93. The method of claim 91, wherein the determining whether the input image is the predetermined pattern image comprises calculating an absolute value of a pixel count difference between adjacent saturation regions of the input image and an average of the absolute values for all of the saturation regions of the input image, and calculating the pattern gain value using the average of the absolute values.

94. The method of claim 91, further comprising:
calculating a mean saturation value of the input image using the calculated saturation values; and
calculating a mean gain value based on the calculated mean saturation value,
wherein a local gain value for each of the pixels is calculated using the calculated mean gain value and the calculated saturation values, and the saturation of each of the pixels of the input image is adaptively adjusted with respect to the local gain value.

95. The method of claim 91, further comprising calculating a saturation histogram of the input image using the calculated saturation values, wherein the peak saturation value is determined from the calculated saturation histogram.

96. The method of claim 91, wherein the saturation of the input image is adaptively adjusted with respect to a system gain value and a user gain value.

97. A method of adjusting a saturation of a color image, comprising:
calculating a saturation value for each of a plurality of pixels of an input image;
determining a peak saturation value of the input image based on the calculated saturation values;
calculating a peak gain value based on the determined peak saturation value;
determining whether each of the pixels of the input image belongs to a color region of the input image and calculating a color gain value for the pixels depending on whether the pixels belong to the color region; and
adaptively adjusting the saturation of the input image using the calculated peak gain value and the calculated color gain value.

98. The method of claim 97, further comprising:
determining whether the input image is a predetermined pattern image; and
calculating a pattern gain value depending on whether the input image is determined to be the predetermined pattern image, wherein
the saturation for each of the pixels of the input image is adaptively adjusted with respect to the calculated pattern gain value.

99. The method of claim 98, wherein the predetermined pattern image is a test pattern image.

100. The method of claim 98, wherein the determining whether the input image is the predetermined pattern image comprises calculating an absolute value of a pixel count difference between adjacent saturation regions of the input image and an average of the absolute values for all of the saturation regions of the input image, and calculating the pattern gain value using the average of the absolute values.

101. The method of claim 100, wherein the determining whether the input image is the predetermined pattern image comprises determining the input image to be the predetermined pattern image if the average of the absolute values is greater than a first threshold, determining the input image to be a natural image if the average of the absolute values is lower than a second threshold, and outputting the pattern gain value corresponding to the input image.

102. The method of claim 97, wherein the color region is a skin color region.

103. The method of claim 102, wherein the determining whether the pixels belong to the skin color region comprises using a 3-dimensional ellipsoidal equation having a mean color value of the skin color region as a center coordinate of the ellipsoid and race- or system-dependent skin color variations as radii of three axes of the ellipsoid, and the color gain value according to the result of the determination is output.

104. The method of claim 97, wherein the determining whether the input pixel belongs to the color region comprises using gain functions for Y, Cb, and Cr values of the input pixels, and a color gain value for a YCbCr value of the input pixels is calculated.

105. The method of claim 97, further comprising:
calculating a mean saturation value of the input image using the calculated saturation values; and
calculating a mean gain value based on the calculated mean saturation value,
wherein a local gain value for each of the pixels is calculated using the calculated mean gain value and the calculated saturation values, and the saturation of each of the pixels of the input image is adaptively adjusted further with respect to the calculated local gain value.

106. The method of claim 105, wherein the calculated mean gain value is lower, when the calculated mean saturation value is less than or equal to a first saturation value and is greater than or equal to a second saturation value, wherein the second saturation value is greater than the first saturation value, than when the calculated mean saturation value is between the first and second saturation values.

107. The method of claim 105, wherein the calculated local gain value is lower, when the saturation value is less than or equal to a first saturation value and when the saturation value is greater than or equal to a second saturation value, wherein the second saturation value is greater than the first saturation value, than when the saturation value is between the first and second saturation values.

108. The method of claim 97, wherein the calculated peak gain value is lower, when the peak saturation value is less than or equal to a first saturation value and when the peak gain value is greater than or equal to a second saturation value, wherein the second saturation value is greater than the first saturation value, than when the peak saturation value is between the first and second saturation values.

109. The method of claim 97, wherein a saturation value of the pixels corresponding to a predetermined percentage of a total number of the pixels from the pixel having a largest saturation value is determined as the peak saturation value.

110. The method of claim 97, further comprising calculating a saturation histogram of the input image using the calculated saturation values, wherein the determining of the peak saturation value comprises determining the peak saturation value from the calculated saturation histogram.

111. The method of claim 110, wherein the calculating of the saturation histogram comprises selectively calculating a saturation histogram for an entire frame of the input image or a saturation histogram for the pixels in a window region of the input image.

112. The method of claim 97, wherein the adaptively adjusting comprises adaptively adjusting the saturation of the input image with respect to a system gain value or a user gain value.

113. A method of adjusting a saturation of a color image, comprising:
calculating a saturation value for each of a plurality of pixels of an input image;
calculating a mean saturation value of the input image using the calculated saturation values;
calculating a mean gain value based on the calculated mean saturation value; and
calculating a local gain value for each of the pixels using the calculated mean gain value and the calculated saturation values and adaptively adjusting the saturation of each of the pixels of the input image using the local gain value.

114. The method of claim 113, wherein the calculated mean gain value is lower, when the mean saturation value is less than or equal to a first saturation value and when the mean saturation value is greater than or equal to a second saturation value, wherein the second saturation value is greater than the first saturation value, than when the mean saturation value is between the first and second saturation values.

115. The method of claim 113, wherein the calculated local gain value is lower when the saturation value is less than or equal to a first saturation value and when the saturation value is greater than or equal to a second saturation value, wherein the second saturation value is greater than the first saturation value, than when the saturation value is between the first and second saturation values.

116. The method of claim 113, further comprising calculating a saturation histogram of the input image using the calculated saturation values, wherein the calculating of the mean saturation value comprises calculating the mean saturation value from the calculated saturation histogram.

117. The method of claim 113, wherein the adaptively adjusting comprises adaptively adjusting the saturation of the input image with respect to a system gain value or a user gain value.

118. A method of adjusting a saturation of a color image, comprising:
calculating a saturation value for each of a plurality of pixels of an input image;
calculating a mean saturation value of the input image using the calculated saturation values;
calculating a mean gain value based on the calculated mean saturation value;
determining whether the input image is a predetermined pattern image and calculating a pattern gain value depending on whether the input image is determined to be the predetermined pattern image; and
calculating a local gain value for each of the pixels using the calculated mean gain value and the calculated saturation values and adaptively adjusting the saturation of each of the pixels of the input image using the local gain value and the calculated pattern gain value.

119. The method of claim 118, wherein the predetermined pattern image is a test pattern image.

120. The method of claim 118, wherein the determining whether the input image is the predetermined pattern image comprises calculating an absolute value of a pixel count difference between adjacent saturation regions of the input image and an average of the absolute values for all of the saturation regions of the input image, and calculating the pattern gain value using the average of the absolute values.

121. The method of claim 118, wherein the calculated mean gain value is lower, when the mean saturation value is less than or equal to a first saturation value and when the mean saturation value is greater than or equal to a second saturation value, wherein the second saturation value is greater than the first saturation value, than when the mean saturation value is between the first and second saturation values.

122. The method of claim 118, wherein the calculated local gain value is lower, when the saturation value is less than or equal to a first saturation value and when the saturation value is greater than or equal to a second saturation value, wherein the second saturation value is greater than the first saturation value, than when the saturation value is between the first and second saturation values.

123. The method of claim 118, further comprising calculating a saturation histogram of the input image using the calculated saturation values, wherein the calculating of the mean saturation value comprises calculating the mean saturation value from the calculated saturation histogram.

124. The method of claim 118, wherein the calculating of the local gain value comprises adaptively adjusting the saturation of the input image with respect to a system gain value or a user gain value.

125. A method of adjusting a saturation of a color image, comprising:
calculating a saturation value for each of a plurality of pixels of an input image;
calculating a mean saturation value of the input image using the calculated saturation values;
calculating a mean gain value based on the calculated mean saturation value;
determining whether each of the pixels of the input image belongs to a color region of the input image and calculating a color gain value for the pixels depending on whether the pixels belong to the color region; and
calculating a local gain value for the pixels using the calculated mean gain value and the calculated saturation values and adaptively adjusting the saturation of each of the pixels of the input image using the local gain value and the calculated color gain value.

126. The method of claim 125, further comprising:
determining whether the input image is a predetermined pattern image; and
calculating a pattern gain value depending on whether the input image is determined to be the predetermined pattern image, wherein the saturation for each of the pixels of the input image is adaptively adjusted with respect to the calculated pattern gain value.

127. The method of claim 126, wherein the predetermined pattern image is a test pattern image.

128. The method of claim 126, wherein the determining whether the input image is the predetermined image pattern comprises calculating an absolute value of a pixel count difference between adjacent saturation regions of the input image and an average of the absolute values for all of the saturation regions of the input image, and calculating the pattern gain value using the average of the absolute values.

129. The method of claim 128, wherein the determining whether the input image is the predetermined image pattern comprises determining the input image to be the predetermined pattern image if the average of the absolute values is greater than a first threshold, determining the input image to be a natural image if the average of the absolute values is less than a second threshold, and outputting the pattern gain value corresponding to the input image.

130. The method of claim 125, wherein the color region is a skin color region.

131. The method of claim 130, wherein the determining whether the input pixel belongs to the skin color region comprises using a 3-dimensional ellipsoidal equation having a mean color value of the skin color region as a center coordinate of an ellipsoid, and race- or system-dependent skin color variations as radii of three axes of the ellipsoid, and the color gain value according to the result of the determination is output.

132. The method of claim 125, wherein the determining whether the input pixel belongs to the color region comprises using gain functions for Y, Cb, and Cr values of the input pixel, and the color gain value for a YCbCr value of the input pixel is calculated.

133. The method of claim 125, wherein the calculated mean gain value is lower, when the mean saturation value is less than or equal to a first saturation value and when the mean saturation value is greater than or equal to a second saturation value, wherein the second saturation value is greater than the first saturation value, than when the mean saturation value is between the first and second saturation values.

134. The method of claim 125, wherein the calculated local gain value is lower, when the saturation value is less than or equal to a first saturation value and when the saturation value is greater than or equal to a second saturation value, wherein the second saturation value is greater than the first saturation value, than when the saturation value is between the first and second saturation values.

135. The method of claim 134, wherein a largest value among the local gain values for the pixels is equal to the calculated mean gain value.

136. The method of claim 125, further comprising calculating a saturation histogram of the input image using the calculated saturation values, wherein the calculating of the mean saturation value comprises calculating the mean saturation value from the calculated saturation histogram.

137. The method of claim 136, wherein the calculating of the saturation histogram comprises selectively calculating a saturation histogram for an entire frame of the input image or a saturation histogram for the pixels in a window region of the input image.

138. The method of claim 125, wherein the calculating of the local gain value comprises adaptively adjusting the saturation of the input image with respect to a system gain value and a user gain value.

139. A method of adjusting a saturation of a color image, comprising:
calculating a saturation value for each of a plurality of pixels of an input image;
determining a peak saturation value of the input image using the calculated saturation values;
calculating a peak gain value based on the determined peak saturation value;
determining whether the input image is a predetermined pattern image and calculating a pattern gain value depending on whether the input image is determined to be the predetermined pattern image;
determining whether the pixels of the input image belong to a color region and calculating a color gain value for the pixels depending on whether the pixels belong to the color region; and
adaptively adjusting the saturation of each of the pixels of the input image using the calculated peak gain value, the calculated pattern gain value, and the calculated color gain value.

140. The method of claim 139, wherein the predetermined pattern image is a test pattern image.

141. The method of claim 139, wherein the color region is a skin color region.

142. The method of claim 139, wherein the adaptively adjusting of the saturation comprises adaptively adjusting the saturation of the input image with respect to a system gain value or a user gain value.

143. A method of adjusting a saturation of a color image, comprising:
calculating a saturation value for each of a plurality of pixels of an input image;
calculating a mean saturation value of the input image using the calculated saturation values;
calculating a mean gain value based on the calculated mean saturation value;
determining whether the input image is a predetermined pattern image and calculating a pattern gain value depending on whether the input image is determined to be the predetermined pattern image;
determining whether the pixels of the input image belong to a color region of the input image and calculating a color gain value for the pixels depending on whether the pixels belong to the color region; and
calculating a local gain value for each of the pixels using the calculated mean gain value and the calculated saturation values and adaptively adjusting the saturation of each of the pixels of the input image using the local gain value, the calculated pattern gain value, and the calculated color gain value.

144. The method of claim 143, wherein the predetermined pattern image is a test pattern image.

145. The method of claim 143, wherein the predetermined color region is a skin color region.

146. The method of claim 143, wherein the saturation of the input image is adaptively adjusted with respect to a system gain value or a user gain value.

147. A method of adjusting a saturation of a color image, comprising:
calculating a saturation value for each of a plurality of pixels of an input image;
determining a peak saturation value of the input image using the calculated saturation values;
calculating a peak gain value based on the determined peak saturation value;
calculating a mean saturation value of the input image using the calculated saturation values;
calculating a mean gain value based on the calculated mean saturation value;
determining whether the input image is a predetermined pattern image and calculating a pattern gain value depending on whether the input image is determined to be the predetermined pattern image;
determining whether each of the pixels of the input image belongs to a color region of the input image and calculating a color gain value for the pixels depending on whether the pixels belong to the color region; and
calculating a local gain value for each of the pixels using the calculated mean gain value and the calculated saturation values and adaptively adjusting the saturation of each of the pixels of the input image using the local gain value, the calculated peak gain value, the calculated pattern gain value, and the calculated color gain value.

148. The method of claim 147, wherein the predetermined pattern image is a test pattern image.

149. The method of claim 147, wherein the color region is a skin color region.

150. The method of claim 147, wherein the saturation of the input image is adaptively adjusted with respect to a system gain value and a user gain value.
